(19) United States
(12) Patent Application Publication
(10) Pub. No.: US 2017/0326860 A1
(43) Pub. Date: Nov. 16, 2017

(54) METHOD FOR PRODUCING A PLASTIC VEHICLE ATTACHMENT PART

(71) Applicant: SAINT-GOBAIN GLASS FRANCE, Courbevoie (FR)

(72) Inventors: Rym BENYAHIA, STUTTGART (DE); Nicolas FOURNIER, LES 2 ALPES (FR); Uwe WEISSENBERGER, WUERZBURG (DE); Matias ACQUARONE, STUTTGART (DE)

(73) Assignee: SAINT-GOBAIN GLASS FRANCE, Courbevoie (FR)

(21) Appl. No.: 15/531,713

(22) PCT Filed: Oct. 14, 2015
(86) PCT No.: PCT/EP2015/073738

§ 371 Date: May 30, 2017

(30) Foreign Application Priority Data
Dec. 18, 2014 (EP) 14198782.6

(51) Int. Cl. B32B 37/02; B32B 37/00; B32B 37/12; B32B 7/12; B32B 27/08; B44C 1/17; B60R 19/52; B60J 1/00; B60Q 1/00; B62D 29/04

(52) U.S. Cl. CPC B32B 37/02; B32B 27/08; B32B 37/025; B32B 37/12; B32B 7/12; B44C 1/1729; B32B 2605/006; B32B 2605/003; B32B 2451/00; B32B 2309/105; B32B 2307/75; B32B 2307/412; B32B 2307/41; B32B 2307/4026; B32B 2605/08; B60J 1/00; B60Q 1/00; B60R 19/52; B62D 29/043; B60R 2019/525

(57) ABSTRACT

A method for producing a polymeric vehicle attachment part with a decorative element is obtained when a polymeric attachment part is prepared, a decorative element is transferred from a carrier film onto a first surface of the attachment part by hot stamping using a stamp, and at least the first surface is provided with a protective coating.

The invention relates to a method for producing a polymeric vehicle attachment part, a polymeric vehicle attachment part, and use thereof.

In the wake of increasingly stringent requirements regarding carbon dioxide emissions of motor vehicles, there are strong efforts to reduce the weight of a vehicle and, hence, its fuel consumption. Constant innovations in the plastics sector enable the replacement of large parts of the metal car body with correspondingly lighter elements made of polymeric materials. In particular, parts or even the entire window region can be replaced by elements made of polymeric materials. In many cases, along with a significantly lower weight, these present hardness, stability, and toughness comparable to that with a car body window made of steel. Additionally, due to the weight reduction, the center of gravity of the vehicle is moved lower, which has a positive effect on handling. Molded parts made of polymeric materials can be produced in virtually any desired shape and geometry.

Many material parts made of plastic must comply with various requirements and functions. In this regard, important parameters are stability, fracture behavior, scratch resistance, impact strength, or notched impact strength. In addition to technical considerations such as weight and strength of the individual components, shape, geometry, and appearance play an increasingly important role. Especially in the automobile industry, in addition to mechanical properties, characteristics in the area of design and aesthetics are also of major significance.

One established method for generating visual effects is the method for film insert molding (FIM). In this method, an appropriate film is laid in the injection mold and back injected with a suitable plastic. In this manner, the surface properties and geometry of polymeric materials can be selectively and versatilely affected and modified. A method for producing polymeric attachment parts using film insert molding is, for example, known from WO2013/050208. Temperatures stable films are an important prerequisite for the use of the method of film insert molding. In addition, imprints situated on the film must be temperature resistant enough to survive back injection with a liquid polymer such as a polycarbonate. If the film is positioned in the injection mold such that it is later arranged on the outside surface on the finished work piece, it is also not protected against external mechanical and chemical influences. In the long run, this can result in damage to the film and the imprint contained on the film.

Film insert molding is a technically very demanding and complex method. Moreover, decorative elements produced by film insert molding are frequently only poorly visible when the film is arranged behind a colored polymeric layer and this polymeric layer has only low transmittance, such as frequently occurs, for example, with vehicle windows.

The object of the invention is to provide another method for producing a polymeric vehicle attachment part with a decorative element. The decorative element should be protected against external influences and enable a visually appealing and readily visible design of the pane. In addition, the method should be easily applicable Industrially.

The object of the invention is accomplished by the method according to claim 1. Preferred embodiments emerge from the subclaims. The polymeric vehicle attachment part according to the invention and its use according to the invention emerge from the coordinated claims. Preferred embodiments emerge from the subclaims.

The method according to the invention for producing a polymeric vehicle attachment part with a decorative element comprises at least the following process steps:

(a) a polymeric attachment part is provided;

(b) a decorative element is transferred from a carrier film onto a first surface of the attachment part by hot stamping using a stamp;

(c) at least the first surface is provided with a protective coating.

The polymeric attachment part (or plastic attachment part) according to the invention is an external attachment part, i.e., an attachment part for the exterior of the vehicle and not for the vehicle interior. The attachment part is preferably an injection molded attachment part. The attachment part is, in particular, a pane (in particular a vehicle window pane, for example, a roof panel, rear window pane, side pane), a pillar cover, a luminaire cover, a radiator grill panel, or a spoiler. A pane serves for separating the vehicle interior from the external environment.

The invention is based on the knowledge that the method of hot stamping onto attachment parts can be used on the exterior of a vehicle. Attachment parts on the exterior are exposed to significantly higher stresses than interior parts. The stresses are in particular mechanical stresses, for example, stone impact, abrasion, and precipitation. Until now, the prevailing opinion has been that an externally applied decorative element is not stable enough to withstand the stresses over the long term. The inventors have surprisingly found that the attachment part and the decorative element are provided with adequate stability and strength to be used on the exterior by means of a protective coating (or hardcoat).

The invention enables, among other things, the visual enhancement and refinement of visible surfaces of plastic vehicle windows, the introduction of information (in the form of text or symbols), the display of a large number of visual effects, and freedom in the color design of the attachment part by means of a large number of available hot stamping foils.

The attachment part is typically designed substantially planar or even platelike and has two main surfaces and a peripheral side edge. One of the main surfaces is the first surface according to the invention of the attachment part, onto which the decorative element is applied. This first main surface is, in particular, that surface that is provided as the outer surface of the attachment part. The term “outer surface” refers to a surface which, in the installed position, faces the external environment of the vehicle.

According to the invention, the decorative element is applied onto the attachment part by hot stamping. Hot stamping is commonly also referred to as vertical stamping. The carrier film with the decorative element is arranged such that the decorative element faces the attachment part. Then, the stamp acts on the surface of the carrier film facing away from the decorative element such that the decorative element is pressed against the first surface. Then, the carrier film is detached, with the decorative element remaining on the first surface. The decorative element preferably occupies only a local subregion of the first surface of the attachment part.

Preferably, the carrier film has the form of a flat film on rolls and carries a large number of decorative elements, with a decorative element arranged under the stamp (in other words, between the stamp and the attachment part) in each case during hot stamping. By means of the rolls, the flat film can be transported farther such that the next decorative element is advanced under the stamp and can be applied on the next attachment part. Thus, economical industrial mass production can be achieved. In practice, the entire carrier film can be provided superficially with a continuous single- or multilayer decorative coating, wherein the individual decorative elements are not separated from one another. The individual decorative elements are not detached from the remaining coating until during the hot stamping by the adhesive action onto the attachment part and thus individualized. The shape of the decorative element is dictated by the design of the contact surface of the stamp. However, the decorative elements can also already be individualized on the carrier film by perforations or incisions in the overall coating, by which means detachment is facilitated.

The stamp has an elevated temperature, which is transferred to the carrier film and the decorative element, by which means the adhesion of the decorative element on the attachment part is promoted. The stamp preferably has a temperature of 120° C. to 250° C., particularly preferably of 140° C. to 200° C. Thus, particularly good results are obtained. The precise temperature depends on the film used as well and can be ascertained by the person skilled in the art from the manufacturer data or determined by routine pretesting.

The contact surface of the stamp preferably contains silicone or is formed from silicone. However, the contact surface can also contain natural or synthetic rubber or other elastomers or be formed therefrom. The advantage resides in the soft design of the contact surface, by means of which damage to the attachment part can be avoided. The contact surface can, however, also be made of metal.

The contact surface of the stamp is naturally significantly smaller than the first surface of the attachment part and acts only on a local subregion of the first surface.

In an advantageous embodiment, the stamp acts with a pressure of 15 kg/cm² to 50 kg/cm² on the first surface, preferably of 20 kg/cm² to 40 kg/cm², particularly preferably of 25 kg/cm² to 35 kg/cm². Thus, particularly good adhesion of the decorative element is obtained, yet the attachment part is unscathed.

The duration of action of the stamp on the first surface of the attachment part for application of the decorative element is preferably at least 1 s, particularly preferably at least 2 s. The duration of action can be, for example, from 1 s to 10 s, preferably from 2 s to 4 s. This is advantageous in terms of good adhesion on the one hand and a short cycle time on the other.

The decorative element is preferably implemented film-like. The decorative element is particularly preferably implemented as a multilayer film. In a particularly advantageous embodiment, the decorative element comprises at least one decorative layer and one adhesive layer. The layers are arranged on the carrier film in the order indicated with increasing distance from the carrier film. The decorative element makes contact with the attachment part via the adhesive layer. When the decorative element is transferred onto the attachment part the order is, with increasing distance from the first surface: adhesive layer—decorative layer.

The adhesive layer effects adhesion between the decorative element and the attachment part. Thus, the adhesion between the decorative element and the attachment part is stronger than between the decorative element and the carrier film, as result of which the decorative element is detached from the carrier film. By means of the adhesive layer, the decorative element is durably stably fixed on the surface of the attachment part. In a preferred embodiment, the adhesive layer contains an acrylic-based adhesive. This effects particularly good adhesion through the formation of covalent bonds and van der Waals forces. This effect is particularly pronounced when the attachment part contains polycarbonate. Alternatively, however, the adhesive layer can also contain other suitable materials that promote adhesion, for example, polyurethane or epoxy resin. The adhesive layer preferably has a thickness of 0.1 μm to 5.0 μm. Thus, good adhesion is obtained without excessively increasing the thickness of the decorative element, which would degrade the visual impression. The adhesive layer is preferably transparent such that the view of the attachment part is not disrupted by the adhesive layer.

The decorative layer carries the actual visual effect of the decorative element. Consequently, it can also be referred to as a color layer. The decorative layer is a polymeric layer, i.e., contains a polymer. A large number of polymers are suitable as a basic material for the decorative layer, for example, polymethylmethacrylate. The decorative layer preferably has a thickness of 1.0 μm to 10.0 μm. In order to produce the visual impression of the decorative element, the decorative layer can, for example, be provided with a print or include embedded colorant. Colorants are pigments or dyes that can be inorganic or organic in nature and colored or achromatic. Suitable as ink or embed are, for example, temperature-stable organic pigments or dyes (such as urethane acrylate polymers, azo dyes, or polycyclic compounds) or inorganic pigments (such as carbon, titanium dioxide, carbon black, cinnabar, bismuth (bismuth vanadate), spinel pigments, pigments of lead, mercury, zirconium, iron, cadmium, copper, cobalt, nickel, and chromium; aluminum silicate (ultramarine)). The decorative layer can be monochromatic or multi-chromatic, include varying shades (for example, various shades of gray), be designed with total or partial surface effects, and/or be implemented as a metallic effect.

In one embodiment of the invention, the decorative layer is the uppermost layer of the decorative element and is in direct contact with the protective coating. When the protective coating is applied as a liquid, the decorative layer can swell and partially diffuse into the material of the protective coating. This has the advantage that the decorative layer is strengthened and is less susceptible to breakage.

In another embodiment, the multilayer decorative element contains a protective layer in addition to the adhesive layer and the decorative layer. The decorative element then includes at least one decorative layer, one adhesive layer, and one protective layer, which are arranged on the carrier film in the order indicated with increasing distance from the carrier film. When the decorative element is transferred onto the attachment part, the order is, with increasing distance from the first surface: adhesive layer—decorative layer protective layer.

The protective layer, which is positioned, in the final state, on the attachment part above the decorative layer, protects the decorative layer against mechanical impact. The protective layer is preferably a protective coating. The protective layer preferably contains preferably an acrylic polymer, polymethylmethacrylate (PMMA), or polyurethane (PU). The protective layer preferably has a thickness of 0.5 μm to 5.0 μm, with which particularly good results are obtained.

The material of the protective layer is preferably coordinated with the material of the subsequently applied protective coating. If the protective coating is multilayered, this coordination refers to the material of that layer that is in direct contact with the protective layer, i.e., for example, a primer. For example and preferably, the protective layer of the decorative element and the protective coating (or the bottommost layer of the protective coating, in other words, the layer of the protective coating, that is least distant from the attachment part) are implemented on an acrylic basis, i.e., contain polyacrylate. This is very advantageous in terms of the adhesion of the protective coating as a result of the formation of covalent bonds and van der Waals forces as well as the interdiffusion of polymer chains.

The total thickness of the decorative element is preferably as much as 100 μm, particularly preferably from 2 μm to 20 μm, most particularly preferably from 4 μm to 10 μm. Thus, a significant visual effect is achieved. However, the decorative element is thin enough not to attract attention as a disruptive bump.

The size and design of the decorative element can be freely selected according to the requirements in the individual case.

The carrier film typically has a thickness from 10 μm to 500 μm, preferably from 10 μm to 50 μm, particularly preferably from 15 μm to 30 μm. However, the carrier film can also be thicker (as result of which it becomes, however, more expensive) or even thinner (so long as adequate stability is ensured). The carrier film preferably contains polyethylene terephthalate (PET), polycarbonate (PC), polybutylene terephthalate (PBT), styrene acrylonitrile (SAN), or mixtures or copolymers thereof. Thus, adequate stability is achieved.

In an advantageous embodiment, a separating layer is arranged between the carrier film and the decorative element. The separating layer facilitates the detachment of the decorative element from the carrier film after the hot stamping. The separating layer has, for example, a thickness of 0.1 μm to 5.0 μm.

It can be advantageous to produce the final decorative element by repeated hot stamping on the attachment part. This means that, at the same position of the attachment part, multiple identically shaped decorative elements are transferred from their carrier film onto the surface of the attachment part congruently covering one another. In this manner, significantly improved opacity and brilliance and an improved color impression of the decorative element can be obtained. However, excessively frequent hot stamping can result in blurred contours of the decorative element. Ideally, the hot stamping is performed two or three times, in particular twice.

According to the invention, at least the first surface of the attachment part is provided with a protective coating after application of the decorative element. Preferably, the entire surface of the attachment part is provided with the protective coating. In a preferred embodiment, the protective coating is applied by flow coating. Thus, a homogeneous coating can be achieved with short cycle times. However, alternatively, other coating methods can also be used, for example, dip or spray coating or in-mold coating methods.

The protective coating it is often also referred to as scratch resistant coating or with the English term “hardcoat”. Preferably used as a protective coating are thermally curing or UV curing coatings, in particular based on polysiloxanes, polyacrylates, polymethyacrylates, polyurethanes, or mixtures or copolymers thereof. The protective coating can have one or a plurality of separately applied layers and preferably has a total thickness from 1 μm to 50 μm, particularly preferably from 2 μm to 25 μm. It gives the attachment park good scratch resistance and weather resistance as well as chemical resistance. In particular, the decorative element is protected. The protective coating can also include UV blockers, preservatives, as well as components for increasing scratch resistance, for example, nanoparticles. In addition, the protective coating can also perform decorative functions, such as luster or pearl effects. The protective coating is cured after application, preferably by heating and/or UV radiation.

The protective coating can be formed by a single layer. The protective coating can, however, also have a plurality of individual layers. Such a multilayer protective coating preferably includes an adhesion promoting coating, a so-called “primer”, below the actual hardcoat. The term “below” means that the primer is arranged between the attachment part and the actual hardcoat. The primer preferably contains polymethylmethacrylate, UV absorber, and alcoholic solvent. The layer thickness of the primer is, for example, from 0.2 μm to 8.0 μm, preferably from 1.0 μm to 4.0 μm.

The polymeric attachment part is preferably produced by injection molding. The polymeric attachment part can be implemented from a single homogeneous material component (or material phase). The material phase can be implemented transparent (as in the case of window pane) or opaque (as in the case of a pillar cover). Often, however, the attachment part includes a plurality of material phases, in particular two material phases, one material phase being implemented transparent and the other material phase opaque. The first surface of the attachment part, which is provided with the decorative element and faces the external environment in the installed position, is typically the surface of the transparent material phase. The transparent material phase and the opaque material phase can be substantially congruent. In that case, the entire attachment part is opaque, with a glasslike visual effect being produced by the transparent material phase. The opaque component can, however, also be present only in subregions of the attachment part. This is, for example, the case with windowpanes, where the opaque component is typically arranged in a peripheral edge region such that the pane can be glued to the vehicle body invisibly for the observer. The decorative element according to the invention can be arranged in the opaque or in the transparent region of the pane. In the context of the invention, “opaque” means that an observer cannot see through the components. The transmittance in the visible spectral range is thus significantly reduced and is less than 10%, preferably less than or equal to 5%, in particular roughly 0%. In the context of the invention, “transparent” means that an observer can see through the components and can recognize objects that are behind the components from the standpoint of the observer. The level of transmittance in the visible spectral range (400 nm to 800 nm) is at least 10%.

An attachment part comprising a plurality of material phases is preferably produced in the multicomponent injection molding process or in the multicomponent injection compression process, particularly preferably in combination with insert technology, rotary table technology, and/or index plate technology. Alternatively, the plastic motor vehicle attachment part can also be produced by insert technology, rotary table technology, and/or index plate technology alone.

The attachment part can, in principle, be made of any polymer that ensures adequate stability. Preferably, the attachment part contains polyethylene (PE), polycarbonate (PC), polypropylene (PP), polystyrene, polybutadiene, polynitrile, polyester, polyurethane, polymethylmethacrylate (PMMA), polyacrylate, polyimide, polyethylene terephthalate (PET), polybutylene terephthalate (PBT), acrylonitrile butadiene styrene (ABS), acrylonitrile styrene acrylester (ASA), acrylonitrile butadiene styrene—polycarbonate (ABS/PC), PET/PC, PBT/PC, or copolymers or mixtures. Particularly preferable are PC, PMMA, SAN, ASA, PET, or copolymers or mixtures thereof.

The polymeric attachment part can contain inorganic or organic fillers, preferably SiO₂, Al₂O₃, TiO₂, clay minerals, silicates, zeolites, glass fibers, carbon fibers, glass beads, organic fibers, and/or mixtures thereof. The fillers can further increase the stability of the attachment part. In addition, the fillers can reduce the polymeric material content and, hence, reduce the production costs.

The thickness (or material thickness) of the attachment part is typically from 1 mm to 20 mm, in particular from 2 mm to 10 mm, in particular when the attachment part is a pillar cover or pane.

The invention also includes a polymeric vehicle attachment part with a decorative element, at least comprising:

a polymeric attachment part,

a decorative element applied onto a first surface of the attachment part by hot stamping, and

a protective coating at least on the first surface with the decorative element.

The preferred embodiments described above in conjunction with the method apply mutatis mutandis to the vehicle attachment part according to the invention.

The invention also includes the use of a polymeric vehicle attachment part according to the invention for external applications in motor vehicles, i.e., as an external attachment part for motor vehicles, preferably as a vehicle window, in particular a window pane, pillar cover, luminaire cover, radiator grill panel, or spoiler.

The invention is explained in detail with reference to drawings and exemplary embodiments. The drawings are a schematic representation and not true to scale. The drawings in no way restrict the invention.

They depict:

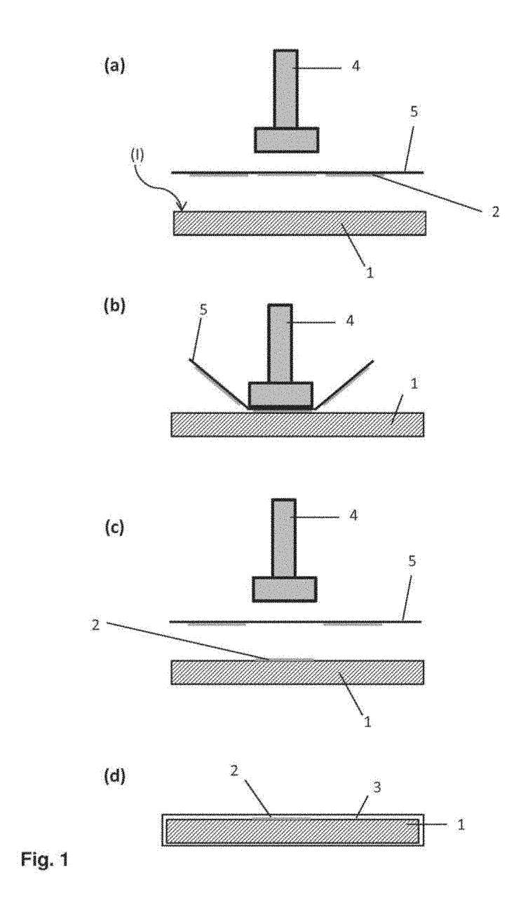

FIG. 1 a cross-section of a polymeric attachment part during the method according to the invention,

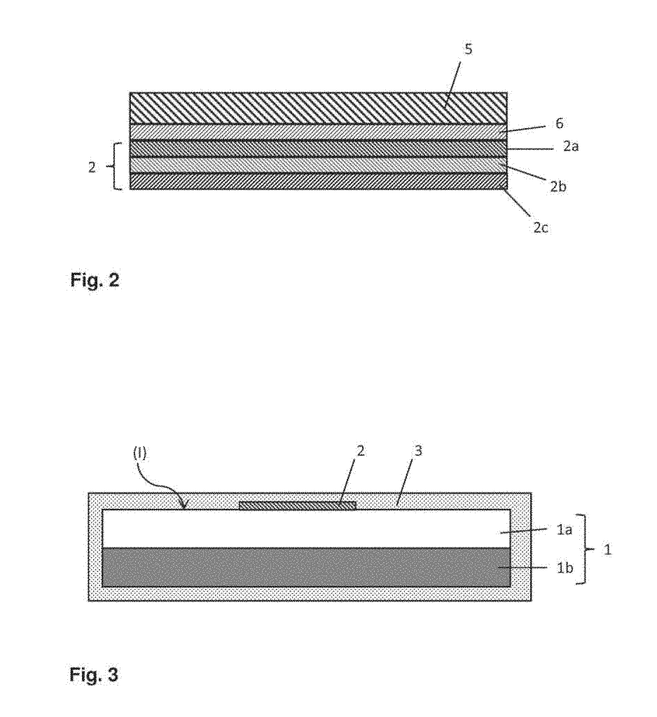

FIG. 2 a cross-section through one embodiment of a carrier film with a decorative element,

FIG. 3 a cross-section through one embodiment of the polymeric attachment part with a decorative element according to the invention, and

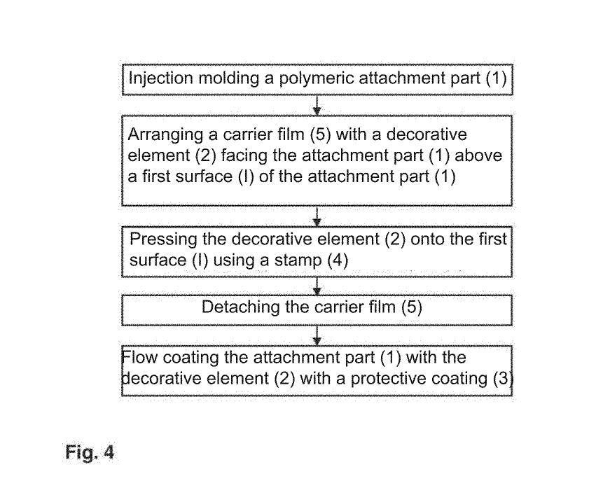

FIG. 4 an exemplary embodiment of the method according to the invention with reference to a flowchart.

FIG. 1 depicts a cross-section of a polymeric attachment part at different times in the method according to the invention: (a) before hot stamping, (b) during hot stamping, (c) after hot stamping, and (d) after application of the protective coating. The polymeric attachment part 1 is, for example, a plastic window for a motor vehicle, for example, a rear side window pane. The polymeric attachment part 1 can, however, also be another external attachment part of a motor vehicle, for example, a pillar cover, a spoiler, or a luminaire cover. The polymeric attachment part 1 is made, for example, of polycarbonate and has a thickness of 4 cm. The window pane, which, in reality, typically consists of two material phases or material components, namely, a transparent material phase comprising the entire surface and an opaque component applied thereon peripherally in the edge region, is depicted homogeneously in the figure for the sake of simplicity. The method according to the invention can also be performed at any location of the attachment part 1, i.e., both in transparent and opaque regions such that the precise structure of the attachment part 1 is not significant.

The attachment part 1 is positioned under a stamp 4 (FIG. 1(a)), with the first surface (I) of the attachment part, which is later provided as the outside surface in the installed position, facing the stamp 4. A decorative element 2 on a carrier film 5 is positioned between the stamp 4 and the attachment part 1. The carrier film 5 is a flat film with a plurality of decorative elements 2 that is rolled onto two rollers (not shown). Thus, the carrier film 5 can be transported farther such that another decorative element 2 is conveyed under the stamp 4 and is provided for application on another attachment part 1.

The decorative element 2 is implemented as a multilayer film, which will be described more precisely in the following. For the sake of better understanding, the various decorative elements 2 are depicted as discrete elements on the carrier film 5. Typically, in reality, the multilayer film will cover the carrier film substantially over its entire surface, with the individual decorative elements 2 being detached from the overall film by adhesive action on attachment part 1. This detachment can also be facilitated by incisions or perforations in the overall film.

The stamp 4 acts on the surface of the carrier film 5 facing away from the decorative element 2 such that the decorative element 2 is pressed onto the first surface (I) of the attachment part 1 (FIG. 1(b)), for example, with a pressure of 30 kg/cm². The stamp 4 has a temperature of, for example, roughly 160° C. The duration of action of the stamp 4 on the surface (I) of the attachment part 1 is, for example, 2.5 s. The action of the stamp 4 is typically accomplished by its lowering onto the attachment part 1, but can also be accomplished, alternatively or additionally, by raising the attachment part 1 toward the stamp 4.

Then, the stamp 4 and the attachment part 1 are again separated from one another and the carrier film 5 is detached, with the decorative element 2 remaining on the surface (I) of the attachment part 1 (FIG. 1(c)).

Then, the attachment part 1 with the decorative element 2 is provided with a protective coating 3 (FIG. 1(d)), which is implemented, for example, in two layers, and comprises an acrylic-based primer and a polysiloxane-based hardcoat applied thereon.

Because of the fact that the decorative element 2 is applied on the outer surface (I) of the attachment part 1, it is always readily discernible later in the installed position, even when the attachment part has low or no light transmittance. This is a major advantage compared to some conventional decorative elements introduced by film insert molding, which are arranged behind the attachment part or at least a component of the attachment part) in the direction of vision. Nevertheless, the decorative element 2 is protected by the protective coating 3 against mechanical damage, as a result of which the hot stamping technique can be used for external parts and also complies with the high stability requirements for motor vehicle parts (Rigid Plastic Glazings, ECE R43 Appendix 14, Class /M). This finding was unexpected and surprising for the person skilled in the art.

FIG. 2 depicts by way of example the structure of a suitable carrier film 5 with a decorative element 2. The carrier film is made of PET and has a thickness of 20 μm. The decorative element 2 consists of three layers, namely, with increasing distance from the carrier film: a protective layer 2a, a decorative layer 2b, and an adhesive layer 2c. The decorative element 2 makes contact with the attachment part 1 via the adhesive layer 2c. The adhesive layer 2c effects strong adhesion between the decorative element 2 and the attachment part 1. The adhesive layer 2c is, for example, a layer of an acrylic-based adhesive with a thickness of 1.0 μm. The decorative layer 2b effects the actual visual impression of the decorative element 2. The decorative layer 2b is, for example, a layer with a thickness of 5.0 μm based on polyacrylate, which is colored by embedded or printed-on pigments or dyes in the form of the desired decoration. The protective layer 2a is, for example, an acrylic-based polymeric layer with a thickness of 1.0 μm. The protective layer protects the decorative layer against mechanical damage when the decorative element 2 is applied on the attachment part 1.

A separating layer 6 that promotes the detachment of the decorative element 2 from the carrier film 5 is arranged between the carrier film 5 and the decorative element 2. The separating layer has, for example, a thickness of 0.5 μm.

FIG. 3 depicts a cross-section through an attachment part 1 according to the invention with a decorative element 2. The attachment part 1 consists of a transparent material phase 1a and an opaque material phase 1b. Such a structure occurs, for example, in the edge region of windowpanes or over the whole surface in pillar covers. In the latter case, the transparent phase produces a glasslike effect with a depth effect on the surface of the opaque phase, which is very appealing visually. The transparent material phase 1a is made, for example, from polycarbonate (PC) and has a thickness of 4 mm. The opaque material phase 1b is made, for example, from a PC/ABS mixture and has a thickness of 2.5 mm. The transparent material phase 1a, which is to face the external environment in the installation position, can be clear and colorless, but can also be tinted or colored, as is the case, for example, with privacy glazings. Nevertheless, the decorative element 2 is readily discernible on the outer surface (I).

The attachment part 1 with the decorative element 2 is provided with a protective coating 3, by which means the attachment part 1 and in particular the decorative element 2 as well are protected against mechanical damage. Without the protective coating 3, the decorative element 2 would be too susceptible to abrasion, as a result of which use of the attachment part 1 as an external attachment part, i.e., in the exterior of the vehicle, would be ruled out. The protective coating 3 and the protective layer 2a of the decorative element 2 are preferably coordinated with one another. If the decorative element 2 of FIG. 2 is used with the acrylic-based protective layer 2a, an acrylic-based primer in combination with a polysiloxane hardcoat is preferably used as the protective coating 3. Thus, the adhesion of the protective layer 3 on the decorative element 2 is advantageously influenced.

The protective coating also includes UV blockers, by means of which the decorative element 2 is protected against fading due to UV irradiation.

The thickness of the protective layer 3 is, for example, roughly 20 μm. The thickness of the protective layer 3 can be constant over the entire attachment part. However, the thickness of the protective layer 3 can also be—as depicted schematically in the figure—somewhat thinner in the region of the decorative element 2 such that the total thickness of the protective coating 3 and the decorative element 2 is approx. equal to the thickness of the protective coating 3 in the regions of the first surface (I) without the decorative element 2. Thus, a homogeneous surface without disruptive bumps is created.

FIG. 4 depicts a flowchart of an exemplary embodiment of the method according to the invention for producing a polymeric vehicle attachment part with a decorative element.

The strength of the adhesive bond of attachment parts with a decorative element produced according to the invention was determined using test procedures per DIN EN ISO 2409 as well as test procedures, as are required by many auto manufacturers, for example, H₂O high-pressure spraying. Scratch or abrasion resistance was tested using the Crock meter test and processing with brushes of a carwash. Here, the layer structure proved to be adequately stable in terms of adhesion, abrasion resistance, and scratch resistance to be used on the outer surface of an external vehicle attachment part. Moreover, UV resistance was tested by intensive UV irradiation. No radiation-induced degradation, such as color shifting, yellowing, fading, micro-fissures, or delamination were observed.

It was unexpected and surprising for the person skilled in the art that a decorative element applied by hot stamping can be used on the external surface of a motor vehicle attachment part. Until now, it was assumed that no adequate abrasion resistance and mechanical resistance can be ensured.

### LIST OF REFERENCE CHARACTERS

(1) polymeric vehicle attachment part

(1a) transparent material phase of 1

(1b) opaque material phase of 1

(2) decorative element

(2a) protective layer of 2

(2b) decorative layer of 2

(2c) adhesive layer of 2

(3) protective coating

(4) stamp

(5) carrier film

(6) separating layer

(I) first surface of 1

1-15. (canceled)

16. A method for producing a polymeric vehicle attachment part with a decorative element, comprising the steps of
a. preparing a polymeric attachment part,
b. transferring a decorative element from a carrier film onto a first surface of the attachment part by hot stamping using a stamp, and
c. providing a protective coating on at least the first surface.

17. The method according to claim 16, wherein step (b) further comprises:
arranging the carrier film with the decorative element such that the decorative element faces the attachment part,
acting the stamp on the surface of the carrier film facing away from the decorative element such that the decorative element is pressed against the first surface, and
detaching the carrier film, wherein the decorative element remains on the first surface.

18. The method according to claim 16, wherein the protective coating comprises thermally curing or UV curing coatings.

19. The method according to claim 18, wherein the protective coating comprises polysiloxanes, polyacrylates, polymethyacrylates, polyurethanes, or mixtures or copolymers thereof.

20. The method according to claim 16, wherein the decorative element includes at least one decorative layer and at least one adhesive layer.

21. The method according to claim 20, wherein the decorative element further comprises a protective layer such that the decorative layer is arranged between the protective layer and the adhesive layer.

22. The method according to claim 16, wherein the thickness of the decorative element is less than or equal to 100 μm.

23. The method according to claim 22, where in the thickness of the decorative element is between 2 μm to 20 μm.

24. The method according to claim 16, wherein a separating layer is arranged between the carrier film and the decorative element.

25. The method according to claim 16, wherein, process step (b) further comprises setting the stamp to a temperature between 120° C. to 250° C.

26. The method according to claim 25, wherein the temperature is between 140° C. to 200° C.

27. The method according to claim 16, wherein the stamp acts with a pressure of 15 kg/cm² to 50 kg/cm² on the first surface with a duration of action of at least 1 second.

28. The method according to claim 27, wherein the pressure is 20 kg/cm² to 40 kg/cm².

29. The method according to claim 27, wherein the pressure is 25 kg/cm² to 35 kg/cm².

30. The method according to claim 27, wherein the duration of action is 2 to 4 seconds.

31. The method according to claim 16, wherein the step c) of providing the protective coating comprises flow coating.

32. The method according to claim 16, wherein the attachment part contains polycarbonate (PC), polymethylmethacrylate (PMMA), styrene acrylonitrile (SAN), acrylonitrile styrene acrylester (ASA), polyethylene terephthalate (PET), or copolymers or mixtures thereof.

33. The method according to claim 16, wherein the attachment part has a thickness between 1 mm and 20 mm.

34. The method according to claim 31, wherein the attachment part has a thickness between 2 mm and 10 mm.

35. The method according to claim 16, wherein the adhesive layer comprises an acrylic-based adhesive.

36. A polymeric vehicle attachment part with a decorative element, comprising:
a polymeric attachment part,
a decorative element applied onto a first surface of the attachment part by hot stamping, and
a protective coating at least on the first surface with the decorative element.

37. A method of using a polymeric vehicle attachment part according to claim 36 as an exterior attachment part for motor vehicles, comprising applying the polymeric vehicle attachment part to a vehicle window, pillar cover, luminaire cover, radiator grill panel, or spoiler.
